(19) United States
(12) Patent Application Publication
(10) Pub. No.: US 2002/0175916 A1
(43) Pub. Date: Nov. 28, 2002

(54) Method for presenting circular dialog windows

(76) Inventors: Michael R. Nichols, La Canada Flintridge, CA (US); George Gerba, Venice, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/124,527

(22) Filed: Apr. 16, 2002

Related U.S. Application Data
(60) Provisional application No. 60/283,921, filed on Apr. 16, 2001.
(60) Provisional application No. 60/283,967, filed on Apr. 16, 2001.

(51) Int. Cl. G06T 11/20

(52) U.S. Cl. 345/440

(57) ABSTRACT

A method is provided for guiding a user through a multi-step process on a computer-generated display. Layered dialogs are displayed, including a currently active dialog and remaining dialogs. Each dialog provides text for guiding the user through a corresponding step. After the current step is completed, the currently active dialog is removed so that a remaining dialog is viewable for guiding the user through an additional step. Additionally, a method for displaying a text string in a computer-generated dialog includes storing the text string as a number of tokens (e.g., words), determining widths of lines in the dialog in which text is to be written, and determining which tokens are to be displayed on which line so that a boundary of the dialog is not exceeded. The line widths may be determined based on chord widths of the dialog according to the dialog's geometry.

### RELATED PRIORITY APPLICATIONS

The present application claims priority to U.S. Provisional Patent Application Serial No. 60/284,399, filed Apr. 17, 2001, attorney docket no. 3063/34P, titled, “Television Program Database Architecture,” which is hereby incorporated herein by reference in its entirety, and to U.S. Provisional Patent Application Serial No. 60/283,921, filed Apr. 16, 2001, attorney docket no. 3063/44P, titled, “Interactive Television Navigation System,” which is hereby incorporated herein by reference in its entirety.

### RELATED APPLICATIONS

The present application is related to the following commonly owned U.S. patent applications:

application Ser. No. 09/103,317, filed Jun. 24, 1998, titled “Method and System for Providing User Interface for Electronic Program Guide,” attorney docket no. 3063/12;

application Ser. No. 09/103,315, filed Jun. 24, 1998, titled “Method and System for Providing Selectable Programming in a Multi-Screen Mode,” attorney docket no. 3063/13;

application Ser. No. 09/104,608, filed Jun. 24, 1998, titled “Method And System For Navigating Through Content In An Organized And Categorized Fashion,” attorney docket no. 3063/15A;

Application serial No. 60/283,967, filed Apr. 16, 2001, titled “Method For Presenting Circular Dialog Windows,” attorney docket no. 3063/53P;

Application serial No. 60/284,118, filed Apr. 16, 2001, titled “Complex Video and Data Service Scheduling Via URLs,” attorney docket no. 3063/39P;

Application serial No. 60/284,117, filed Apr. 16, 2001, titled “Ranking of Unrated Content in Interactive Television Navigational System,” attorney docket no. 3063/44BP;

Application serial No. 60/284,141, filed Apr. 16, 2001, titled “Special Titles in Interactive Program Guide,” attorney docket no. 3063/44CP; and

Application serial No. 60/283,968, filed Apr. 16, 2001, titled “Purchase Blocking Clarification and PPV Events in Television Multiscreen Browser,” attorney docket no. 3063/44DP;

All of the above applications are hereby incorporated by reference in their entirety into this application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention generally relates to computer graphics. Specifically, the invention is drawn to a circular dialog containing text to be displayed to the end user that is properly laid out within the bounds of the area created by the dialog, and to a series of layered dialogs that guide a user through a multi-step process.

### BACKGROUND OF THE INVENTION

For the most part, dialog boxes or dialogs are used by computer systems to prompt users to system state changes or to request information from the user. They are typically drawn within a rectangular window and provide software buttons to allow a user to make choices or dismiss the dialog. A benefit of using rectangular windows is that it is relatively simple to determine how to lay out text within the dialog without crossing the bounds of the box. When contemplating the use of complex shapes for a dialog, it becomes difficult to determine how to properly place the dialog text.

Various techniques are known in the art of computer graphics to achieve the presentation of complex display objects or animations. These techniques primarily involve manipulating off-screen objects and moving them onto the screen. A primary approach would be to draw in a rectangle in an off-screen buffer and then place other objects within it. While this technique can be used to draw text into a complex dialog, there is a significant performance deficiency.

New techniques are needed to allow complex objects to be used as dialogs while eliminating the overhead associated with existing methods of drawing text within a bounded area.

The present invention addresses the above and other issues.

### SUMMARY OF THE INVENTION

It is an object of the present invention to create a new type of circular dialog that is unlike those used by current computer operating systems.

It is a further object of the present invention to produce a new method of creating a circular dialog that properly places text within the circle while eliminating the overhead required by existing methods.

Another object of the present invention is to create a new type of circular dialog that incorporates a peephole window containing a scrollable list of options or data that a user can select from.

Still another object of the invention is create a series of circular dialogs, which are layered on top of one another to represent multiple steps involved in a process to be performed by the user.

The invention accomplishes some of these objects by using calculations derived from the font metrics of the text that is to be drawn within the dialog. These calculations determine how many words of a string can fit on a particular line without crossing the bounds of the dialog. Once the program determines which words will fit on which lines within the circle, the string segments are written to an array. The dialog or dialogs are then drawn on the display device. Finally, the text is read out of the array one element at a time, centered within the circle, and drawn to the display device.

In one embodiment, the present invention provides a method of drawing a circular dialog box with properly placed text, the method including providing a text string, creating a drawing region to draw the dialog in, determining which words from the string can be written on each consecutive line and storing the results for each line, drawing a dialog circle within the drawing region, drawing the text string within the circle, and placing the words comprising the string on consecutive lines as previously determined. The method may further include applying a transparent fill to said drawing region not occupied by said drawing circle, so as to eliminate the extraneous portions from the view of the user. The method may also further include applying a beveled edge to the dialog circle, so as to create a three dimensional appearance.

A further particular method for displaying a text string in a computer-generated dialog includes the step of storing the text string as a plurality of tokens. Respective widths of respective lines in the dialog in which text is to be written are determined. Also, it is determined which tokens are to be displayed on which of the respective lines by determining, for successive ones of the respective lines, an associated number of tokens whose combined width does not exceed the respective line width. The dialog may be rounded, or otherwise have a varying width (e.g., such as a shape with multiple straight edges—e.g., triangular, diamond shaped, etc.), such that the width of each line must be determined to determine how much text can be accommodated without crossing a boundary of the dialog.

A further particular method for guiding a user through a multi-step process on a computer-generated display includes the step of displaying a plurality of layered dialogs on the display, including a currently active dialog and at least one remaining dialog. Each dialog provides text for guiding the user through a corresponding one of the steps in the multi-step process, and the currently active dialog is viewable by the user for guiding the user through a current step of the process, and, after the current step is completed, the currently active dialog is removed so that the at least one remaining dialog is viewable for guiding the user through at least one additional step of the process.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1A-1B show a sequence of exemplary screenshots of a multi-step process that utilizes circular dialogs and peephole menus;

FIG. 2 is a flow diagram showing an exemplary process of drawing circular dialogs with text onto a display device in accordance with one embodiment of the present invention;

FIG. 2A illustrates the determination of a chord length for a dialog;

FIG. 3A is a flow diagram showing part of a method of breaking a string of text into smaller strings that can be consecutively drawn within a dialog circle without crossing the bounds of the circle in accordance with one embodiment of the present invention;

FIG. 3B is a flow diagram showing part of a method of breaking a string of text into smaller strings that can be consecutively drawn within a dialog circle without crossing the bounds of the circle in accordance with one embodiment of the present invention;

FIG. 4 is a flow diagram showing an exemplary process of drawing the circles onto the display device in accordance with one embodiment of the present invention;

FIG. 5 is a flow diagram showing a method of the properly drawing text within the dialog circle in accordance with one embodiment of the present invention;

FIG. 6 is an illustration of circular dialogs drawn in accordance with one embodiment of the present invention.

### DETAILED DESCRIPTION OF THE INVENTION

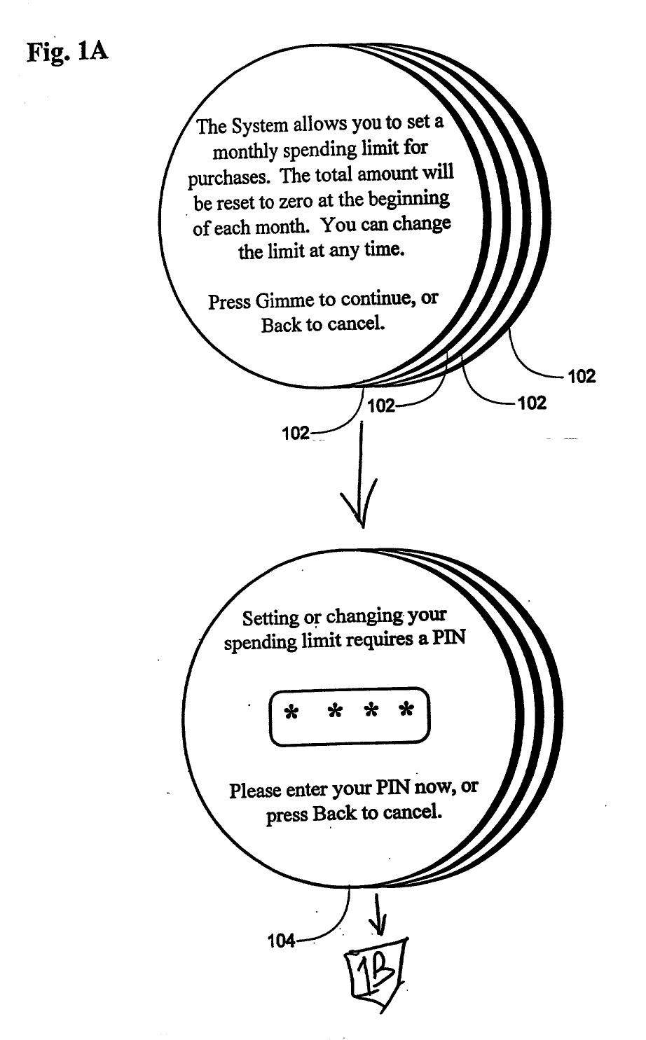

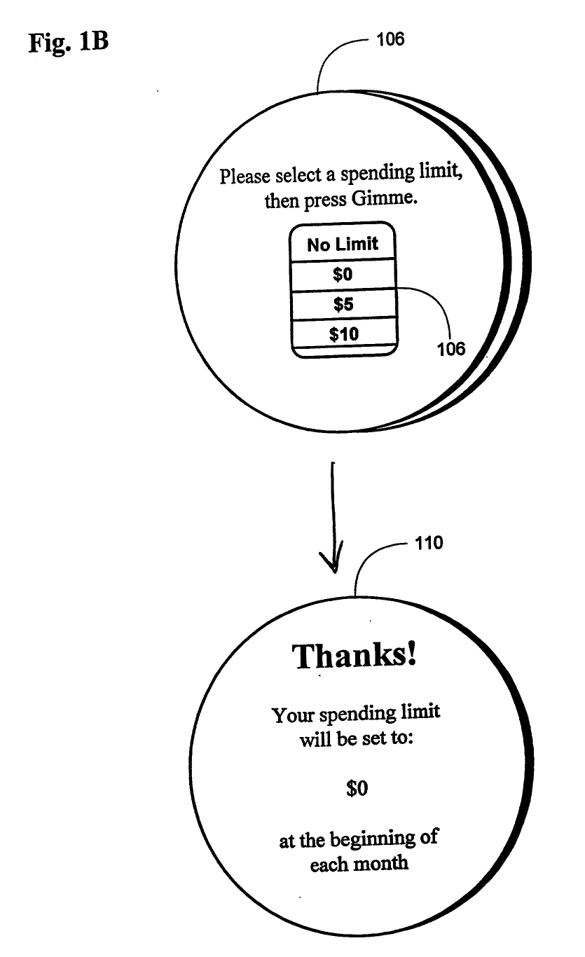

Referring to FIGS. 1A-1B, a computer system generates a graphical user interface showing apparently layered multiple dialogs in response to a user request to perform a multi-step process. The number of apparent layered dialogs 102 generated and shown will correspond to the number of steps that are involved in the process requested by the user. After the user has interacted with the first dialog, representing the first step in the requested process, it is “wiped” from the screen to reveal the next dialog in the process 104. In one embodiment these sequentially accessed screens are separately generated using techniques such as those described below. In those embodiments, the layered dialogs shown behind the current dialog are not actually separate windows in the sense of a conventional Microsoft Windows environment in which a window may be minimized or closed to reveal other windows, but rather are graphical elements around or next to the open dialog window which give the appearance of representing subsequent dialog windows.

Turning to FIG. 1B, the third dialog in the process is presented, which requires the user to select one of several alternative choices 106. Various choices are presented to the user by way of a “peephole” menu 106. The peephole menu acts as a window to a set of data that, depending on the amount of data, is too large to be displayed in its entirety. In the example presented 106, the viewable data includes spending limits that include: no limit, $0, $5 and $10. There may be, however, numerous other choices that are not currently viewable due to the height of the peephole menu, e.g., additional spending limits such as $20, $30 and so forth. The choices not currently viewable may be brought into view by the user scrolling the list either up or down, depending which end of the list is being viewed. Alternatively, the list of data within the peephole menu may loop, such that when the end of the list is reached the next element displayed in the peephole will be the beginning of the list, or vice versa.

As each step is finished, the completed dialog will be “removed” and the next dialog will be visible to the user, with the remaining dialogs in the process displayed behind the currently active dialog. In some embodiments, this removal is done by displaying a different, separately generated screen display, e.g., the four screens shown in the sequence in FIGS. 1A-1B represent four different screen displays shown in sequence, with each screen being shown following the prior one as a user interacts in the proper manner. Processing will continue in a similar manner for each step in the process requested by the user. After the all steps in the process have been completed, the final dialog 110 will be visible and the process completed. As a result, users will see where they are in a process and how much longer (e.g., how many additional steps) they have until completion.

In one embodiment of the invention, a software program draws circular dialogs with properly placed text onto a display device. While the embodiment presented herein is described using object-oriented techniques, one of skill in the art would recognize that the invention can be implemented using any type of programming language or framework.

The software is implemented by creating two classes of objects, referred to as the DialogCircle and DialogLines classes. An instance of each class can be used to create a single circular dialog with properly spaced text laid within the circle. The DialogCircle class can also be used to create a nested (e.g., layered) group of related dialogs, such as several dialogs that need to be interacted with in order to complete a purchase in an interactive environment.

In an object-oriented framework, such as Java, a line of text, including, e.g., letters and numbers, is manipulated as an object. The text object has associated font information that can be extracted by a method that receives the text as a parameter. An exemplary DialogLines object may take a string of text and populate the structure using the following pseudocode:

DialogLines(String text)

{

Font lineFont=text.getFont( );

String dialogText =text;

String FontName=lineFont.getName( );

Integer fontSize=lineFont.getSize( );

}

It will be clear to one skilled in the art that the pseudocode is one way in which the described data structure can be created and that many variations are possible by utilizing various languages and programming techniques.

The DialogLines data structure is used to hold information regarding each line of text that is to be written to the dialog. The structure holds information such as the text of the string for a particular line, the name of the font being used, the point size of the font, and the font color. An array of these structures is created, with each array element representing the data comprising a line of text to be written to the dialog. Thus, an array of data structures can be used to keep track of the number of lines of text as well as the words comprising each line of text.

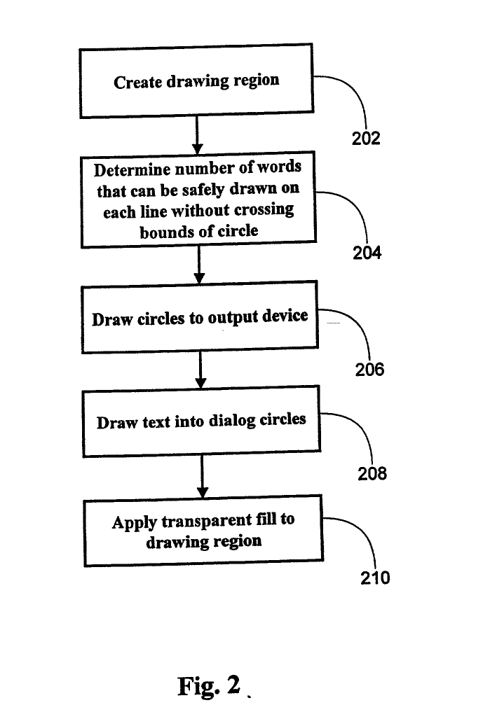

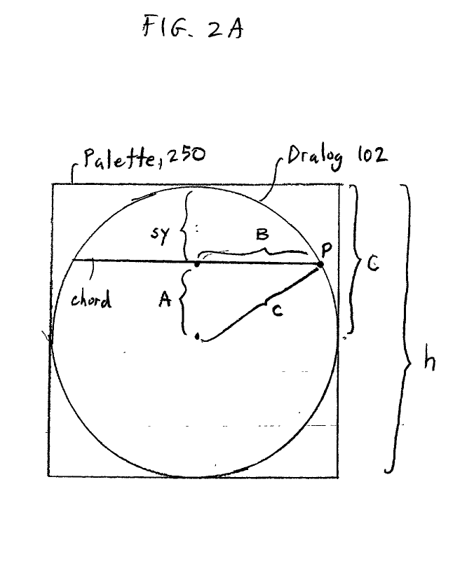

The DialogCircle class handles the business logic of creating the circular dialog and properly placing text within the bounds of the circle. Turning to FIG. 2, a flow diagram is presented outlining a process of properly creating dialogs according to the method presented herein. Refer also to FIG. 2A, which illustrates the determination of a chord length for a dialog.

Referring to step 202, a “palette” or drawing area 250 is first created in the shape of a square or rectangle. The circular or other rounded dialog or dialogs will be drawn within this region. As will be appreciated by those skilled in the art, a square palette is particularly suitable for use with a circular dialog, while a rectangular palette is particularly suitable for use with other rounded shapes for the dialog, such as a oval or ovoid. After the dimensions of the region that the dialog will be drawn to have been calculated, i.e., the dimensions of the palette, the text that is to be written within the dialog must be properly spaced within the circular or other rounded area 204, as described in greater detail below.

Once the string of text is properly laid out within the circular area, the circular dialog or dialogs are drawn to the output device 206. The text is then placed within the dialog 208 as determined in step 204. After the completed dialogs are drawn to the display device, a transparent fill is applied to the area of the palette not occupied by the dialog 210 so the user will see only the dialogs and screen elements that lie behind the dialog.

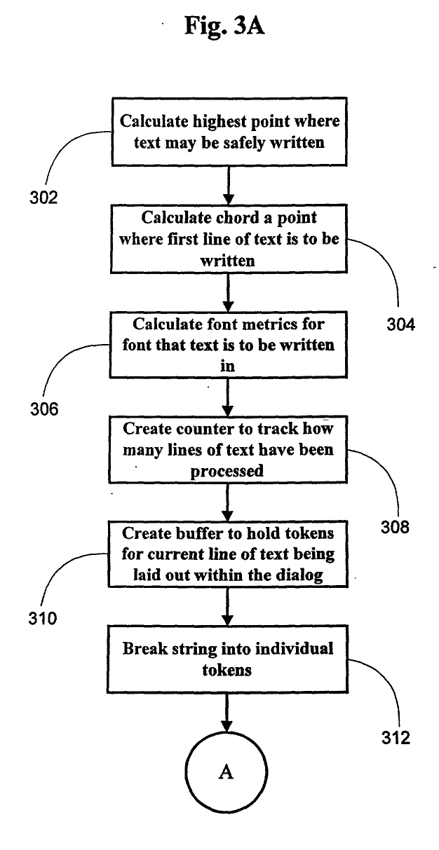

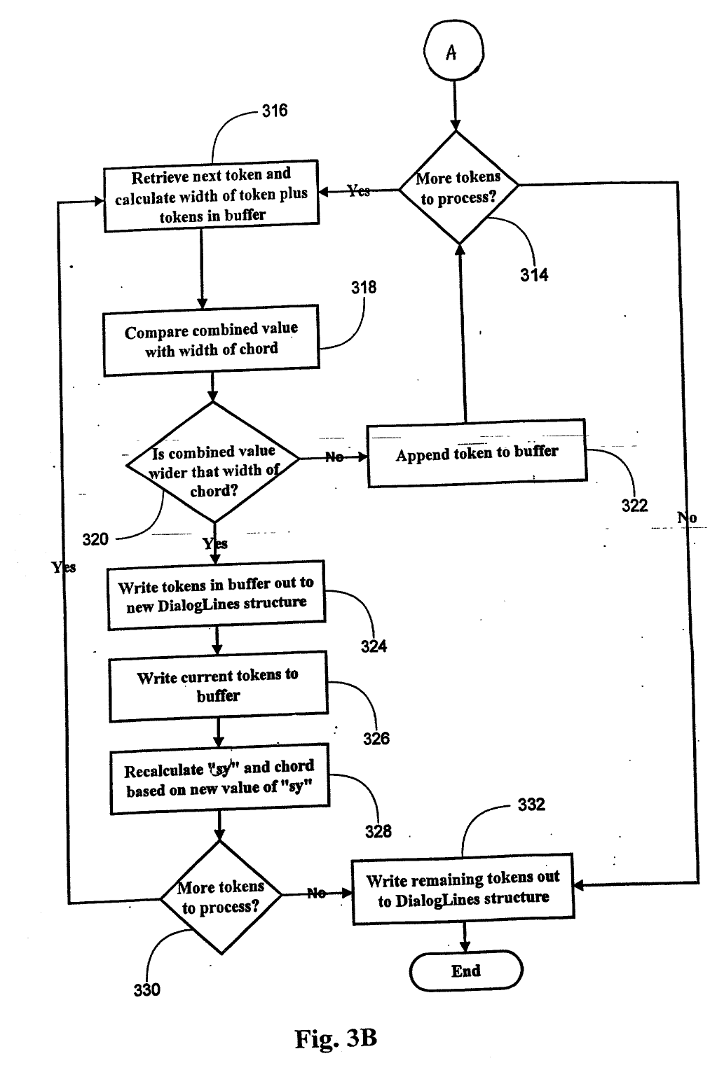

Referring to FIG. 3A, the first step in properly placing text within a dialog is to calculate the highest possible point where text may be safely written without crossing the bound of the circle 302. This value is determined by taking a starting point that is a constant distance from the edge of the circle or other shape. The height of the font utilized by the text is then subtracted from the constant to derive the point where the first line of text of the dialog will be drawn. This value is stored in a variable, referred to here as “safety” or “sy” for short (see FIG. 2A). This point is then used to calculate a chord or horizontal line through the circle 304, which passes through the point stored in the variable “safety”, which has an initial value. Generally, the chord is taken as a horizontal line for horizontal text, but can be inclined for inclined text. The chord represents the number of pixels across the circle or other rounded shape at the point where the first line of text will be drawn, and is calculated by applying the following equations.

A=(height of the palette/2)−sy

C=(height of the palette/2)

B=the square root of (C²−A²)

Chord=(2*B), where B is a real integer

Here, the height of the palette (h) is the same as the diameter of the circle formed by the dialog 102, and C=h/2 is the radius, the distances A, B and C form an isosceles triangle. Each successive line of text is drawn below the previous line, and B is re-calculated accordingly. As can be seen, B will generally vary for each successive line. The value of “sy” is incremented for each line as discussed below. For other rounded but non-circular shaped dialogs, a similar isosceles triangle can be formed where the distance C is the distance from the center of the dialog to the edge of the dialog at a point that is horizontal with respect to “sy” (e.g., example point P in FIG. 2A). Basic geometric principles and equations can be applied in this regard as will be appreciated by those skilled in the art. The software then calculates the font metrics for the particular font used to draw the text into the dialog 306. The font metrics are used to calculate the width of the string to determine if it will fit within the circle or if it should be placed on a subsequent line.

A counter, referred to as “topLine”, is set to keep track of how many lines of text have been processed thus far; it is initially set to zero 308. A “line buffer” is also created to hold the tokens for the current line of text that is being laid out in the dialog, which is also initially set to zero 310. The string is then broken into individual tokens 312, with each token representing a word or word break in the string. Once the string is broken into tokens, the following process is repeated until no more tokens remain to be written to the dialog.

Turning to FIG. 3B, a loop is set to loop through all of the tokens that comprise the string 314. The width of the first token is added to the value contained in the line buffer 316. Since the line buffer is initially set to zero, this combined value will simply be the width of the string. This value is compared to the length of the chord to determine if the token is wider than the space available to write characters 318. If the token is not wider than the chord 320, it is appended to the buffer for the current line 322 and the next token is analyzed 314.

Where the value contained in the buffer plus the width of the current token is greater than the width of the chord 320, i.e., the width of the processed tokens plus the current token will be written out of the bounds of the circular dialog, the following routine is executed. First, the tokens held in the buffer are written to the current empty element in the DialogLines structure and the value of “topLine” is incremented by one 324. The current token is then written to the buffer 326, overwriting the tokens that have been written to the DialogLines structure. The value of “safety” is then incremented by a value equal to the height of the font, so the next line of text will appear directly below the current line, and the new value of “safety” is used to calculate the value of the chord for the next line of text 328.

Processing continues for the remaining tokens in an identical manner 330 until all tokens are processed. When there are no more tokens to process, the token or tokens currently held in the buffer are written to a final DialogLines data structure 332. This structure is then placed in the next empty element in DialogLines array. Once this process is complete, each element in the array of DialogLines structures will contain a line of text to be written to the circular dialog. Furthermore, each line will be capable of being written within the bounds of the dialog. After the system has calculated the number of words that can safely fit on each line, the next step is to draw the dialog and text onto the display device.

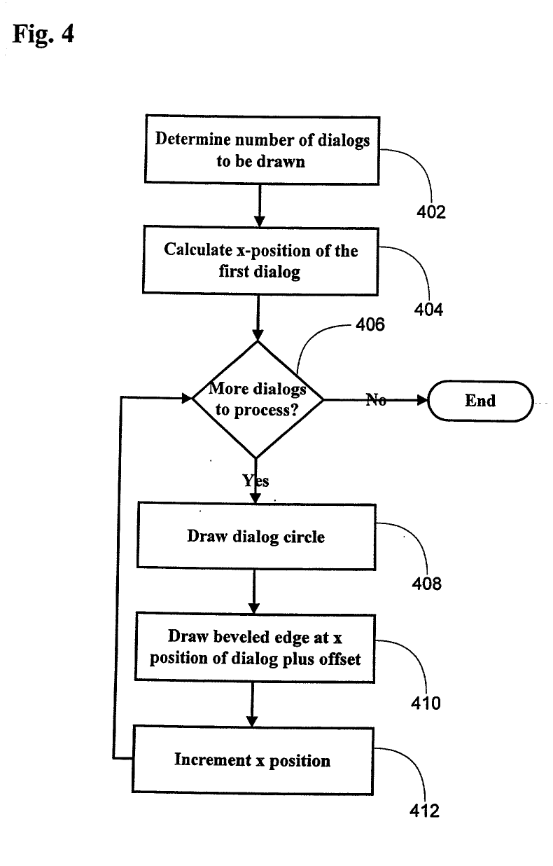

Turning to FIG. 4, the first step in the draw process is to determine the number of nested/layered dialogs that are going to be drawn 402. Nested dialogs are used to visually alert the user that they must complete several steps in a multiple step process, with a separate dialog drawn to correspond to each step. Once the DialogCircle class receives the number of dialogs to be displayed, the x-position of the first dialog is calculated 404 by the following equation:

x Position=(numberOfDialogs*Y pixels)−Y pixels

After the x-position is determined, the following steps are executed in a loop until all the dialogs have been drawn 406. The first circle is drawn using the x-position, which was previously calculated, and a y-position that is based on the height (h) of the drawing area or “palette” 408. As one skilled in the art will recognize, rounded but non-circular dialogs may be drawn by using different values for x and y, including, e.g., oval, ovoid (egg-shaped), elliptical, and the like. Moreover, other shapes may be accommodated, such as triangular, diamond shaped and so forth. The chord discussed above is understood to include a straight line joining two points on a curve of the rounded dialog. For some shapes, a horizontal line that is analogous to a chord may be used.

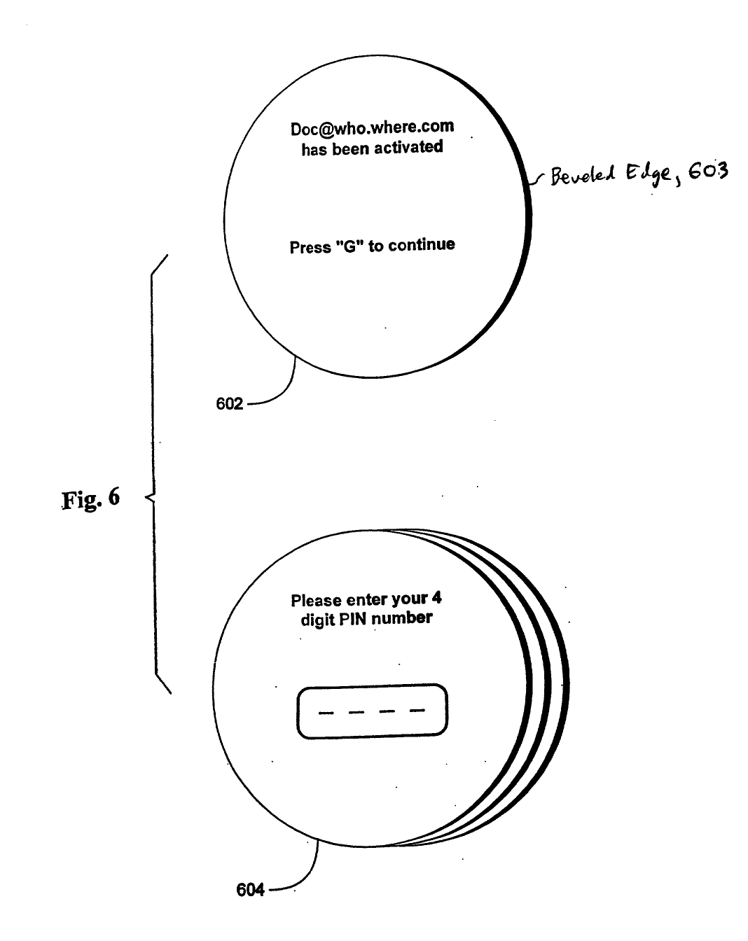

The dialog is then optionally provided with a beveled edge (see, e.g., edge 603 in FIG. 6), which is calculated by drawing another circle with an opaque fill offset by a set number of pixels from the x-position used to draw the dialog circle 410. In one embodiment of the invention, an offset of five pixels is used, although any number of pixels may be used depending on the preference of the developer. Finally, the x-position is incremented 412 by Y pixels, where the value of Y is the same as that used in the equation to calculate the x position of the circle. These steps are then repeated for each dialog to be drawn. This results in several overlapping circular areas, each with a beveled edge. Because the several dialogs are overlapping, only the topmost dialog will have text written to it.

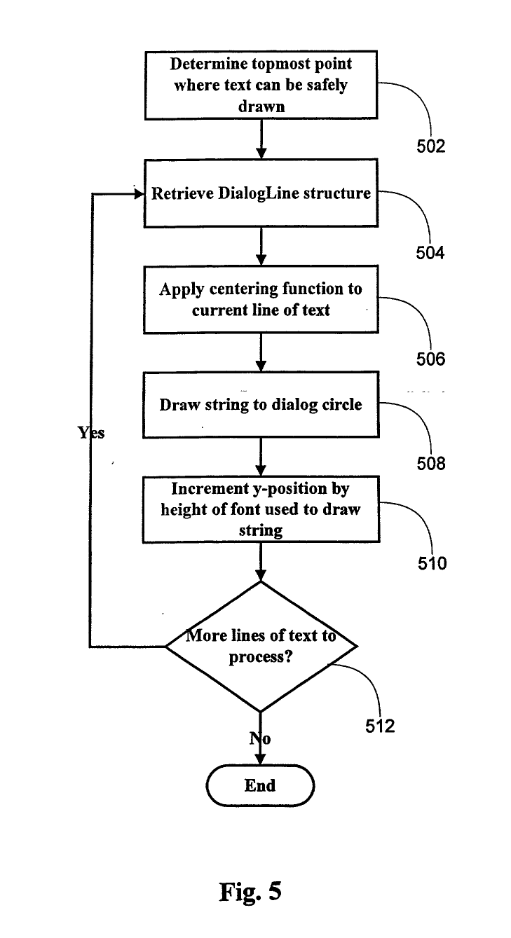

Turning to FIG. 5, after the dialogs are drawn, the text that was previously placed into the DialogLines structures must be drawn. The y-coordinate that marks the topmost point where text can safely be written is set 502 and the following loop is executed, with one iteration of the loop for each element in the array of DialogLines 504 that was previously created. First, the x-position of the text within the dialog is computed by applying a centering calculation 506, which centers the text based on the width in pixels of the current line of text. The line of text is then drawn into the dialog at the computed x and y coordinates 508. The y position is then incremented by the height of the font, including a desired vertical spacing, that the text is written in 510. The loop is then executed again for each subsequent line of text stored in the DialogLines array 512.

The end result of this process will be several overlapping dialogs, each with a beveled edge. After the method of the present invention is executed, a transparent fill is applied to the remaining area of the palette that is not occupied by the dialogs 210 (FIG. 2). Applying a transparent fill allows only the dialog and information sitting directly behind it to be visible to the user. FIG. 6 presents a single dialog circle 602 and a nested group of dialog circles 604 created by applying the instant method. As can be seen from the figures, the topmost dialog will have its associated text written within the dialog on several lines such that the text can be centered and displayed without running over the bounds of the dialog.

Accordingly, it can be seen that the present invention provides, in one aspect, a method for guiding a user through a multi-step process on a computer-generated display. The method includes the step of displaying a plurality of layered dialogs on the display, including a currently active dialog and at least one remaining dialog. Each dialog provides text for guiding the user through a corresponding one of the steps in the multi-step process, and the currently active dialog is viewable by the user for guiding the user through a current step of the process, and, after the current step is completed, the currently active dialog is removed so that the at least one remaining dialog is viewable for guiding the user through at least one additional step of the process.

A further aspect of the invention provides a method for displaying a text string in a computer-generated dialog that includes the step of storing the text string as a plurality of tokens. Respective widths of respective lines in the dialog in which text is to be written are determined. Also, it is determined which tokens are to be displayed on which of the respective lines by determining, for successive ones of the respective lines, an associated number of tokens whose combined width does not exceed the respective line width.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for guiding a user through a multi-step process on a computer-generated display, comprising:
displaying a plurality of layered dialogs on the display, including a currently active dialog and at least one remaining dialog; wherein:
each dialog provides text for guiding the user through a corresponding one of the steps in the multi-step process; and
the currently active dialog is viewable by the user for guiding the user through a current step of the process, and, after the current step is completed, the currently active dialog is removed so that the at least one remaining dialog is viewable for guiding the user through at least one additional step of the process.

2. The method of claim 1, wherein:
at least one of the dialogs provides choices from which the user can select.

3. The method of claim 1, wherein:
a final dialog is visible after all steps in the process have been completed.

4. The method of claim 1, wherein:
a portion of each remaining dialog is displayed such that the user can determine how many additional steps remain in the process until completion.

5. The method of claim 1, wherein:
the dialogs appear with beveled edges.

6. The method of claim 1, further comprising:
applying a transparent fill to areas of the display that are not occupied by the dialogs.

7. The method of claim 1, wherein:
the dialogs have corresponding shapes.

8. A method for displaying a text string in a computer-generated dialog, comprising:
storing the text string as a plurality of tokens;
determining respective widths of respective lines in the dialog in which text is to be written; and
determining which tokens are to be displayed on which of the respective lines by determining, for successive ones of the respective lines, an associated number of tokens whose combined width does not exceed the respective line width.

9. The method of claim 8, wherein:
widths of successive ones of the tokens are combined to determine the associated number of tokens whose combined width does not exceed the respective line width.

10. The method of claim 8, wherein:
a first of the respective lines is spaced down from a top of the dialog according to an initial safety distance; and
each successive line is spaced down according to an associated safety distance.

11. The method of claim 10, wherein:
each of the safety distances accounts for a text height of the tokens which are displayed.

12. The method of claim 8, wherein:
the dialog is rounded, and the respective line widths are determined based on respective chord widths of the dialog.

13. The method of claim 12, wherein:
the respective chord widths vary according to the rounded shape of the dialog.

14. The method of claim 12, wherein:
the respective lines are spaced down from a top point of the dialog according to respective safety distances; and
the dialog is circular, and, for each respective line, the chord width is determined from C=√(B²−A²), where A=a distance from a center of the dialog to a point determined by a respective safety distance, and C=a radius of the dialog.

15. The method of claim 8, further comprising:
for each respective line, storing successive ones of the tokens in a buffer until the associated number of tokens whose combined width does not exceed the respective line width is reached, and subsequently writing the tokens stored in the buffer to an element of an array;
wherein each element of the array stores the tokens which are to be displayed on a respective one of the lines.

16. The method of claim 8, wherein:
the dialog is rounded.
